(19) United States
(12) Patent Application Publication
(10) Pub. No.: US 2006/0006866 A1
(43) Pub. Date: Jan. 12, 2006

(54) Mri system with a conductive member having a damping effect for vibrations

(76) Inventors: Nicolaas Bernardus Roozen, Eindhoven (NL); David Biloen, Eindhoven (NL); Johannes Adrianus Overweg, Uelzen (DE)

Correspondence Address: PHILIPS INTELLECTUAL PROPERTY & STANDARDS, 595 MINER ROAD, CLEVELAND, OH, 44143, US

(21) Appl. No.: 10/518,982

(22) PCT Filed: Jun. 13, 2003
(86) PCT No.: PCT/IB03/02871

§ 371 Date: Dec. 21, 2004

(30) Foreign Application Priority Data
Jul. 4, 2002 (EP) 02077687.8

(51) Int. Cl. G01V 3/00

(52) U.S. Cl. 324/318

(57) ABSTRACT

The invention relates to a magnetic resonance imaging (MRI) system (1) comprising an examination volume (11) in which a patient to be examined can be accommodated, a main magnet system (3) for generating a magnetic field having a main field portion (17) in the examination volume with a substantially constant magnetic field strength (B0), and a gradient magnet system (13) for generating gradients of the main field portion. The MRI system further comprises a damping member (25, 27) which is mounted to a part (5) of the MRI system susceptible to vibrations relative to the magnetic field during operation. Said damping member comprises an electrically conductive member (29, 35, 37) which is present in the magnetic field and in which eddy currents are generated as a result of said vibrations. According to the invention, the conductive member (29, 35, 37) is arranged in a secondary portion of the magnetic field at a distance from the main field portion (17), which secondary portion has a magnetic field strength which differs by more than 25% from the magnetic field strength (B0) of the main field portion. In this manner, the distance between the conductive member and the main field portion is sufficiently large to prevent the eddy currents in the conductive member from causing unacceptable distortions of the main field portion, while, on the other hand, the magnetic field strength in said secondary portion is still sufficiently large to provide an adequate damping effect of the damping member (25, 27). The damping member (25, 27) can for example be mounted to a housing (5) of the main magnet system (3). Alternatively, the damping member (139, 141) can be mounted to the gradient magnet system (127). In another embodiment the damping member (27) is mounted to a rigid portion of the MRI system (1), for example to the supporting member (21), which does hardly vibrate during operation. In this embodiment, the damping member (27) is used to damp the vibrations of the magnetic field generating portions (9) of the main magnet system (3).

The invention relates to a magnetic resonance imaging (M) system comprising an examination volume, a main magnet system for generating a magnetic field having a main field portion with a substantially constant magnetic field strength in the examination volume, a gradient magnet system for generating gradients of the main field portion, and a damping member which is mounted to a part of the MRI system susceptible to vibrations relative to the magnetic field during operation, said damping member comprising an electrically conductive member which is present in the magnetic field and in which eddy currents are generated as a result of said vibrations.

An MRI system of the kind mentioned in the opening paragraph is known from U.S. Pat. No. 6,326,788. The known MRI system, which is used to make images of the entrails of a patient's body by means of a nuclear magnetic resonance method, comprises a cylindrical examination volume, which is enclosed by a cylindrical magnet housing in which the main magnet system and the gradient magnet system are accommodated. In order to limit the time necessary for an examination, the gradients of the main field portion of the magnetic field are altered at relatively high frequencies. For this purpose, the electric currents in the coils of the gradient magnet system are altered at high frequencies. The electrically conductive member of the known MRI system is a cylindrical closed metal plate, which is rigidly mounted to the gradient magnet system and is arranged between the gradient magnet system and the main magnet system. The conductive member is used as an eddy current shield which limits the generation of unwanted eddy currents in the conductive portions of the main magnet system under the influence of the alternating magnetic field of the currents in the gradient magnet system.

As a result of the electromagnetic interaction between the magnetic field of the main magnet system and the altering currents in the coils of the gradient magnet system, alternating Lorentz forces are exerted on said coils causing unwanted mechanical and acoustic vibrations of the gradient magnet system. In order to limit the transmission of said mechanical vibrations to the main magnet system and further to the other parts of the known MRI system, the gradient magnet system is resiliently mounted to the main magnet system. In this manner, particularly the transmission of mechanical vibrations with a relatively high frequency from the gradient magnet system to the main magnet system and other parts of the MRI system is limited. As a result of the fact that the gradient magnet system is resiliently mounted to the main magnet system, however, vibrations with a relatively low frequency of the gradient magnet system relative to the main magnet system occur, which lead to distortions of the gradients of the main field portion of the magnetic field and to distortions of the image generated by the MRI system. Although not explicitly described in U.S. Pat. No. 6,326,788, said low frequency vibrations of the gradient magnet system of the known MRI system are damped and thus limited by the presence of the conductive member in the magnetic field of the main magnet system, the conductive member thus additionally forming a damping member for vibrations of the gradient magnet system. Said damping effect of the conductive member is caused by additional eddy currents in the conductive member, which are generated as a result of the fact that the conductive member is rigidly mounted to the gradient magnet system and therefore vibrates relative to the magnetic field. The electromagnetic interaction between said additional eddy currents and the magnetic field lead to Lorentz forces, exerted on the conductive member, which damp the vibrations of the conductive member and, accordingly, also the vibrations of the gradient magnet system rigidly mounted to the conductive member. Although in this manner distortions of the main field portion of the magnetic field and distortions of the image caused by vibrations of the gradient magnet system can be limited to an acceptable level, a disadvantage of the known MRI system is that the eddy currents in the conductive member lead to unacceptable distortions of the main field portion of the magnetic field and to unacceptable distortions of the image generated by the MRI system.

It is an object of the present invention to provide a magnetic resonance imaging (MRI) system of the kind mentioned in the opening paragraph in which distortions of the main field portion of the main magnet system and distortions of the image caused by the eddy currents in the conductive member are limited to an acceptable level without limiting the vibration damping effect of the damping member.

In order to achieve this object, a magnetic resonance imaging (3R) system according to the invention is characterized in that the conductive member is arranged in a secondary portion of the magnetic field at a distance from the main field portion, the secondary portion having a magnetic field strength which differs by more than 25% from the magnetic field strength of the main field portion. The invention is based on the insight that a relation exists between the degree, to which the magnetic field strength of the main field portion of the magnetic field is influenced by the presence of eddy currents in a position at a predetermined distance from the main field portion, and the magnetic field strength of the magnetic field in said position. As said distance increases, on the one hand, the difference between the magnetic field strength of the magnetic field in said position and the magnetic field strength of the main field portion will increase and, on the other hand, the influence of eddy currents present in said position on the magnetic field strength of the main field portion will strongly decrease. It was found that the level, at which the magnetic field strength of the main field portion is distorted by the presence of eddy currents in a predetermined position in the magnetic field, is acceptably low if the magnetic field strength of the magnetic field in said predetermined position differs by more than 25% from the magnetic field strength of the main field portion. As according to the invention the conductive member of the damping member is arranged in said secondary portion of the magnetic field where the magnetic field strength differs by more than 25% from the magnetic field strength of the main field portion, the distortion of the main field portion by the eddy currents generated in the conductive member will be acceptable. As in said secondary portion the magnetic field strength is up to 75%, or even 125% or more, of the magnetic field strength of the main field portion, the eddy currents generated by the magnetic field in the conductive member will be sufficiently strong to provide a sufficiently large damping effect.

A particular embodiment of an MRI system according to the invention is characterized in that the magnetic field strength of the secondary portion differs by more than 50% from the magnetic field strength of the main field portion. In positions in the magnetic field, where the magnetic field strength differs by more than 50% from the magnetic field strength of the main field portion, the distance to the main field portion is so large that the influence of eddy currents in said position on the magnetic field strength of the main field portion is negligible. Also in this embodiment, the eddy currents generated in the conductive member by the local magnetic field, which has a magnetic field strength of up to 50%, or even 150% or more, of the field strength of the main field portion, appears to be strong enough to provide a sufficiently large damping effect.

A particular embodiment of an MRI system according to the invention is characterized in that the conductive member is arranged in a stray field portion of the magnetic field. The stray field of the magnetic field of the main magnet system is usually present at a relatively large distance from the main field portion, so that in this particular embodiment the eddy currents in the conductive member have a negligible influence on the magnetic field strength of the main field portion. On the other hand, however, the magnetic field strength of the stray field is considerable, so that the eddy currents in the conductive member still provide a considerable damping effect.

A particular embodiment of an MRI system according to the invention is characterized in that the conductive member is mounted to the gradient magnet system. In this embodiment the damping member is used to damp vibrations of the gradient magnet system relative to the main magnet system and other parts of the MRI system. Vibrations of the gradient magnet system are caused by alternating Lorentz forces exerted on the gradient magnet system as a result of the electromagnetic interaction between the altering currents in the gradient magnet system and the magnetic field of the main magnet system. Said vibrations of the gradient magnet system constitute the main source for mechanical and acoustic vibrations of the MRI system, so that in this embodiment the damping member is effectively used.

A further embodiment of an MRI system according to the invention is characterized in that the main magnet system comprises a first substantially rotationally symmetrical portion and a second substantially rotationally symmetrical portion at a distance from the first portion, wherein the examination volume is present between the first and the second portion, and wherein the gradient magnet system comprises a first and a second portion arranged, respectively, in a central cavity of the first portion of the main magnet system and in a central cavity of the second portion of the main magnet system, a first and a second conductive member being mounted, respectively, to the first portion of the gradient magnet system and to the second portion of the gradient magnet system and being arranged, respectively, in a portion of the central cavity of the first portion of the main magnet system remote from the examination volume and in a portion of the central cavity of the second portion of the main magnet system remote from the examination volume. In this embodiment the MRI system is of the so-called open type, wherein the examination volume is open and easily accessible as a result of its position between said two portions of the main magnet system. Each portion of the gradient magnet system is mounted to a separate damping member, so that the vibrations of each individual portion of the gradient magnet system are effectively damped. The portions of said central cavities, which are remote from the examination volume, constitute a practical and efficient housing for the conductive members of the damping members in that sufficient space is present for the accommodation of the conductive members, in that sufficient distance to the examination volume is present to prevent unwanted distortions of the main field portion of the magnetic field by the eddy currents in the conductive members, and in that the magnetic field in said central cavities has a sufficiently large magnetic field strength to provide an adequate damping effect.

A yet further embodiment of an MRI system according to the invention is characterized in that the first and the second conductive member each comprise a substantially circular cylindrical metal plate which is concentrically arranged relative to, respectively, the first portion of the main magnet system and the second portion of the main magnet system. Usually the portions of the central cavities remote from the examination volume are circular cylindrical. In this yet further embodiment the volumes of said portions of the central cavities are optimally used for the accommodation of the conductive members as a result of the circular cylindrical shape of the conductive members. Since the magnetic field in the central cavities is oriented substantially parallel to the central axes of the central cavities, the magnetic field is oriented substantially parallel to the plates of the conductive members, as a result of which an effective damping effect is achieved.

A yet further embodiment of an MRI system according to the invention is characterized in that the first and the second conductive member each comprise a closed conductive metal winding having winding portions extending substantially parallel to a central axis of, respectively, the first portion of the main magnet system and the second portion of the main magnet system. Since the magnetic field in the central cavities is oriented substantially parallel to the central axes of the central cavities, the magnetic field is oriented substantially parallel to said winding portions of the conductive members, as a result of which an effective damping effect is achieved. A further advantage of the windings is that the shape of the windings can be optimized so as to minimize the influence of the eddy currents in the windings on the main field portion of the magnetic field.

A particular embodiment of an MRI system according to the invention is characterized in that the conductive member is mounted to a housing of the main magnet system. In this embodiment the damping member is used to damp vibrations of the housing of the main magnet system relative to the main magnet system and other parts of the MRI system. Vibrations of said housing are for example caused by vibrations which are transmitted from the gradient magnet system to said housing. Since the housing usually comprises relatively large portions having specific resonance frequencies for mechanical vibrations, mechanical vibrations of the housing at said resonance frequencies are easily intensified, and as a result constitute an important source of mechanical and acoustic vibrations of the MRI system if no measures are taken. In this particular embodiment the damping member provides an effective damping effect for said vibrations of the housing of the main magnet system.

A further embodiment of an MRI system according to the invention is characterized in that the main magnet system and the gradient magnet system are substantially circular cylindrical, wherein the gradient magnet system surrounds the examination volume and the main magnet system surrounds the gradient magnet system, the conductive member being mounted to an annular end wall of the housing of the main magnet system. In this embodiment the MRI system is of the so-called closed cylindrical type, wherein the examination volume is substantially completely surrounded by the gradient and main magnet systems. The annular end walls of the housing of the main magnet system constitute a practical and efficient part of said housing for mounting the conductive member of the damping member in that sufficient space is present for the accommodation of the conductive member, in that sufficient distance to the main field portion of the magnetic field in the examination volume is present to prevent unwanted distortions of the main field portion by the eddy currents in the conductive member, and in that the magnetic field at the location of said end walls has a sufficiently large magnetic field strength to provide an adequate damping effect.

A further embodiment of an MRI system according to the invention is characterized in that the main magnet system and the gradient magnet system are substantially circular cylindrical, wherein the gradient magnet system surrounds the examination volume and the main magnet system surrounds the gradient magnet system, the conductive member being mounted to a portion of a cylindrical outer wall of the housing of the main magnet system adjacent to an annular end wall of said housing. In this embodiment the MRI system is of the so-called closed cylindrical type, wherein the examination volume is substantially completely surrounded by the gradient and main magnet systems. Said portion of the cylindrical outer wall of the housing of the main magnet system constitutes a practical and efficient part of said housing for mounting the conductive member of the damping member in that sufficient space is present for the accommodation of the conductive member, in that sufficient distance to the main field portion of the magnetic field in the examination volume is present to prevent unwanted distortions of the main field portion by the eddy currents in the conductive member, and in that the magnetic field at the location of said portion of the cylindrical outer wall has a sufficiently large magnetic field strength to provide an adequate damping effect

A further embodiment of an MRI system according to the invention is characterized in that the conductive member is mounted to a support member which supports the housing of the main magnet system. The support member of the housing of the main magnet system usually constitutes a comparatively rigid part of the MRI system in which the level of mechanical vibrations is comparatively small. Since in this further embodiment the conductive member is mounted to the comparatively rigid support member, the damping member is used to damp mechanical vibrations of the magnetic field generating portions of the main magnet system relative to the support member and relative to the surroundings of the MRI system. Vibrations of said portions of the main magnet system are for example caused by vibrations which are transmitted from the gradient magnet system to said portions. Said vibrations are unwanted because they lead to distortions of the main field portion of the magnetic field. In this further embodiment the damping member provides an effective damping effect for said vibrations of the magnetic field generating portions of the main magnet system.

A further embodiment of an MRI system according to the invention is characterized in that the conductive member comprises a substantially flat metal plate. The flat metal plate provides a particularly effective damping effect.

In the following, embodiments of an MRI system in accordance with the invention will be described in detail with reference to the Figures, in which

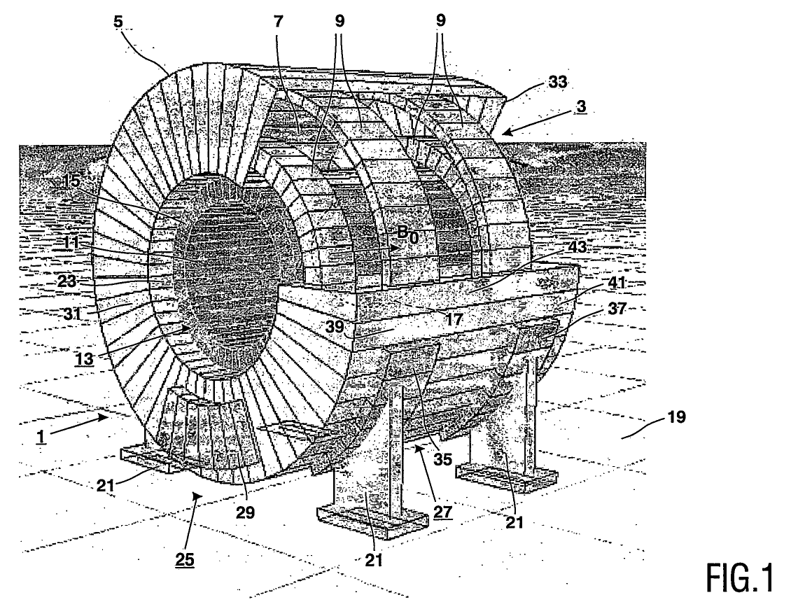

FIG. 1 schematically shows a first embodiment of an MRI system in accordance with the invention,

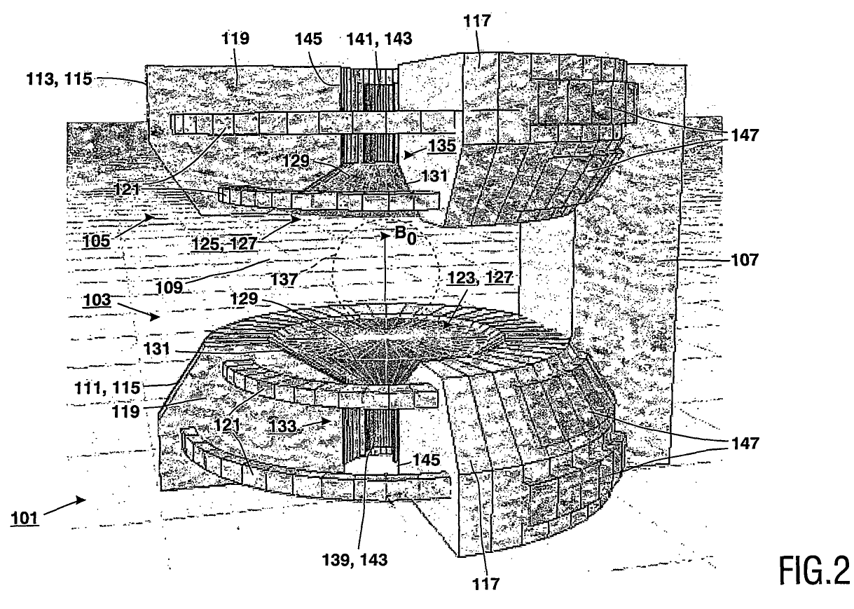

FIG. 2 schematically shows a second embodiment of an MRI system in accordance with the invention, and

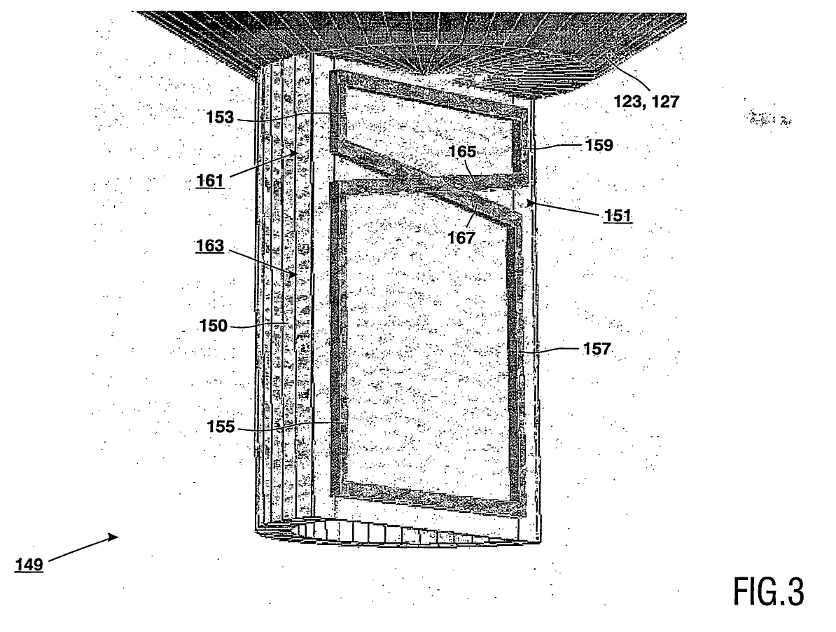

FIG. 3 schematically shows an alternative conductive member of an MRI system in accordance with the invention.

FIG. 1 schematically shows the main components of a first embodiment of an MRI system 1 in accordance with the invention. The MRI system 1 is of the so-called closed cylindrical type and is used to make images of the entrails of a patient's body by means of a nuclear magnetic resonance method. For this purpose the MRI system 1 comprises a main magnet system 3 comprising a substantially circular cylindrical housing 5 in which a cryogenic container 7 is present accommodating a number of annular superconducting electric coils 9. In FIG. I the housing 5 is only partially drawn, so that a part of the superconducting coils 9 is visible. The MRI system 1 further comprises an examination volume 11 in which a patient to be examined can be positioned. In this open type MRI system 1, the examination volume 11 is substantially completely surrounded by the main magnet system 3. The MRI system 1 also comprises a gradient magnet system 13 comprising a substantially circular cylindrical housing 15 accommodating a number of electrical gradient coils not shown in FIG. 1. The gradient magnet system 13 is arranged between the main magnet system 3 and the examination volume 11, so that the main magnet system 3 surrounds the gradient magnet system 13 and the gradient magnet system 13 surrounds the examination volume 11. During operation the superconducting coils 9 of the main magnet system 3 are used to generate a magnetic field which has a main field portion 17 with a substantially constant magnetic field strength B₀ in a portion of the examination volume 11. The gradient coils of the gradient magnet system 13 are used to generate altering gradients of the main field portion 17 in order to select a series of successive positions in the patient's body to be imaged in accordance with the nuclear magnetic resonance method used. The housing 5 of the main magnet system 3 is supported on a horizontal floor 19 by means of a support member, comprising four rigid feet 21 in the embodiment shown, while the housing 15 of the gradient magnet system 13 is mounted to an inner wall 23 of the housing 5 of the main magnet system 3 by means of mounting members not shown in FIG. 1.

A known problem of MRI systems is the presence of mechanical and acoustic vibrations in the MRI system. Said vibrations are mainly caused by alternating Lorentz forces which are exerted on the gradient coils of the gradient magnet system 13 as a result of electromagnetic interaction between the magnetic field of the main magnet system 3 and the altering currents in the gradient coils, which are necessary to generate the required gradients of the main field portion 17. In order to limit the time necessary for an examination, said gradients and accordingly also the currents in the gradient coils are altered at relatively high frequencies. As a result, said Lorentz forces and the vibrations caused thereby have both low-frequency components and high-frequency components, which are transmitted from the gradient magnet system 13 to the main magnet system 3 and to other components of the MRI system 1. The transmission of the high-frequency components of the vibrations is considerably limited by mounting the gradient magnet system 13 to the main magnet system 3 by means of elastic suspension members, not shown in FIG. 1. However, a small portion of the high-frequency components of the vibrations will be transmitted to the main magnet system 3. The transmission of the low-frequency components of the vibrations cannot be avoided by means of said elastic suspension members. Accordingly, part of the vibrations of the gradient magnet system 13 will be transmitted to the main magnet system 3 and will cause unwanted mechanical vibrations of the housing 5 of the main magnet system 3 and of the magnetic field generating portions of the main magnet system 3, in particular of the superconducting coils 9. Since the housing 5 usually comprises relatively large parts having a number of specific resonance frequencies for mechanical vibrations, mechanical vibrations of the housing 5 at said resonance frequencies can be easily intensified and, as a result, constitute an important source of mechanical and acoustic vibrations of the MRI system I if no measures are be taken. Mechanical vibrations of the superconducting coils 9 are unwanted because they lead to distortions of the main field portion 17 and, as a result, to distortions of the image generated by the MRI system 1.

In order to limit the vibrations of the housing 5, the MRI system 1 comprises a first damping member 25 and a second damping member 27. The first damping member 25 comprises a number of electrically conductive members, in this embodiment a number of substantially flat plates 29 made of a material having a relatively high electrical conductivity, preferably a metal such as copper or aluminium. The flat plates 29 are mounted to an annular end wall 31 of the housing 5 of the main magnet system 3. It is noted that, for the sake of simplicity, only one flat plate 29 is shown in FIG. 1, but that in reality in this embodiment a plurality of such flat plates is circumferentially arranged along the annular end wall 31 at regular mutual distances. In the embodiment shown, similar flat plates, which are not visible in FIG. 1, are mounted to the annular end wall 33 of the housing 5 opposite to the end wall 31. The second damping member 27 also comprises a number of electrically conductive members, in this embodiment a number of curved plates 35, 37 which are also made of a material having a relatively high electrical conductivity, preferably a metal such as copper or aluminium. The curved plates 35 and 37 are mounted, respectively, to a first portion 39 and to a second portion 41 of a cylindrical outer wall 43 of the housing 5 of the main magnet system 3, said first portion 39 being adjacent to the annular end wall 31 of the housing 5 and said second portion 41 being adjacent to the other annular end wall 33 of the housing 5. It is noted that, for the sake of simplicity, only one curved plate 35 and one curved plate 37 are shown in FIG. 1, but that in reality in this embodiment a plurality of such curved plates 35, 37 are circumferentially arranged along, respectively, said first portion 39 and said second portion 41 at regular mutual distances.

The vibration damping effect of the damping members 25 and 27 is obtained as follows. The plates 29, 35, 37 of the damping members 25, 27 are each present in a stray field portion of the magnetic field of the main magnet system 3. As a result of the vibrations of the housing 5 the plates 29, 35, 37 will vibrate relative to the magnetic field of the main magnet system 3 because the plates 29, 35, 37 are mounted to the housing 5. As a result of these movements of the plates 29, 35, 37 relative to the magnetic field, eddy currents will be induced in the plates 29,35, 37 by the magnetic field. These movements will be damped by the Lorentz forces which are exerted on the plates 29, 35, 37 as a result of the electromagnetic interaction between these eddy currents and the magnetic field of the main system 3. Since the plates 29, 35, 37 are mounted to the housing 5, the vibrations of the housing 5 will also be damped.

In order to limit the vibrations of the magnetic field generating portions of the main magnet system 3, in particular of the superconducting coils 9, two of the curved plates 35 and two of the curved plates 37 of the second damping member 27 are each rigidly mounted to one of the four rigid feet 21. It is noted that in FIG. 1 only one curved plate 35 and one curved plate 37, each mounted to one of the feet 21, are visible. Since said two curved plates 35 and said two curved plates 37 are rigidly mounted to the rigid feet 21, the level of mechanical vibrations of said four plates 35, 37 is comparatively low. As a result, the eddy currents generated in said four plates 35,37 are mainly caused by movements of the magnetic field of the main magnet system 3 relative to said four plates 35, 37, i.e. by the vibrations of the superconducting coils 9 relative to the rigid feet 21 and the floor 19. Said vibrations of the superconducting coils 9 will be damped by electromagnetic reaction forces which are exerted on the superconducting coils 9 as a result of electromagnetic interaction between said eddy currents in said four plates 35, 37 and the magnetic field of the main magnet system 3.

An advantage of the position of the flat plates 29 on the annular end walls 31 and 33 and the position of the curved plates 35, 37 on the first and second portions 39 and 41 of the cylindrical outer wall 43 is that said positions are at such distances from the main field portion 17 in the examination volume 11 that the eddy currents in the flat plates 29 and in the curved plates 35, 37 hardly influence the magnetic field strength B₀ of the main field portion 17. As a result, said eddy currents do not lead to unacceptable distortions of the main field portion 17 and of the image generated by the MRI system 1. On the other hand, the magnetic field at the locations of the plates 29, 35,37 is sufficiently strong and, as a result, the eddy currents induced in the plates 29, 35, 37 are sufficiently large to provide an adequate damping effect for the vibrations of the housing 5 and of the superconducting coils 9. The invention is however not limited to embodiments wherein the conductive member of the damping member is arranged in a position as discussed before and as shown in FIG. 1. Other positions for the conductive member are also possible within the scope of the invention. In general it was found that the conductive member should be arranged in a secondary portion of the magnetic field of the main magnet system 3 at a distance from the main field portion 17, for example in a stray field portion as in the embodiment of FIG. 1, wherein the magnetic field strength in said secondary portion should differ by more than 25% from the magnetic field strength B₀ of the main field portion 17. In positions of the magnetic field where the magnetic field strength differs by more than 25% from the magnetic field strength B₀ of the main field portion 17, the distance to the main field portion 17 appears to be so large that eddy currents present in such positions do not lead to unacceptable distortions of the main field portion 17. Suitable positions for the conductive member in accordance with the invention can be determined by the skilled person from measurements or calculations of the magnetic field of the main magnet system 3. In general a sufficiently large damping effect is obtained if the conductive member is arranged in a suitable position thus determined, because the magnetic field strength in such a position is up to 75% or even 125% or more of the magnetic field strength B₀ of the main field portion 17. A particularly suitable position for the conductive member is a position in the magnetic field of the main field system 3 where the magnetic field strength differs by more than 50% from the magnetic field strength B₀ of the main field portion 17. In such a position, the distance to the main field portion 17 is so large that the influence of eddy currents in said position on the magnetic field strength of the main field portion 17 is even negligible. On the other hand, an adequate damping effect is still obtained because the magnetic field strength in such a position is up to 50% or even 1 50% or more of the magnetic field strength B₀ of the main field portion 17.

An advantage of the use of the flat plates 29 and of the curved plates 35, 37 as the conductive members of the damping members 25, 27 is that said plates 29,35, 37 provide a particularly effective damping effect. However, other kinds of conductive members can also be used instead, as will be discussed hereafter. In general, for a conductive member, an optimum damping effect is achieved if the conductive member has an electrical conductivity such that a time constant of the eddy currents in the conductive member is in a range wherein a period time of the mechanical vibrations to be damped is present. If the time constant of the eddy currents in the conductive member, i.e. the time during which the strength of an induced eddy current is approximately halved as a result of the electrical resistance of the conductive member, is in the range wherein the period time of the mechanical vibrations to be damped is present, the electromagnetic interaction between the magnetic field and said eddy currents provides an optimum damping force on the conductive member. The necessary time constant of the eddy currents is achieved by a suitable electrical conductivity of the conductive member, i.e. by a suitable combination of the material, the shape, and the dimensions of the conductive member.

In the embodiment of FIG. 1 the conductive members of the damping members 25, 27 are mounted to the housing 5 in order to limit the vibrations of the housing 5 relative to the magnetic field of the main magnet system 3 and to limit the vibrations of the superconducting coils 9 relative to the rigid feet 21. The invention also covers embodiments in which the conductive member of the damping member is mounted to another part of the I system susceptible to vibrations relative to the magnetic field during operation in order to damp said vibrations. In the second embodiment of an MRI system 101 according to the invention as shown in FIG. 2, for example, the conductive member of the damping member is mounted to the gradient magnet system in order to damp vibrations of the gradient magnet system relative to the main magnet system and the other parts of the MRI system 101. FIG. 2 only schematically shows the main components of the MRI system 101, which is of the so-called open type. The MRI system 101 comprises a lower part 103 and an upper part 105 at a vertical distance from the lower part 103, the lower part 103 and the upper part 105 being mutually connected by a vertical post 107. Between the lower part 103 and the upper part 105 an open examination volume 109 is present, which is easily accessible. The lower part 103 and the upper part 105 respectively comprise a first substantially rotationally symmetrical portion 111 and a second substantially rotationally symmetrical portion 113 of a main magnet system 115 of the MRI system 101. Each portion 111, 113 of the main magnet system 115 comprises a housing 117 in which a cryogenic container 119 is present accommodating a number of annular superconducting electric coils 121. It is noted that in FIG. 2 the housings 117 are only partially shown, so that parts of the superconducting coils 121 are visible. The lower part 103 and the upper part 105 further comprise, respectively, a first portion 123 and a second portion 125 of a gradient magnet system 127 of the MRI system 101. Each portion 123, 125 of the gradient magnet system 127 has a substantially conical housing 129 accommodating a number of electrical gradient coils not shown in FIG. 2. The first portion 123 and the second portion 125 of the gradient magnet system 127 are arranged in a conical portion 131 of, respectively, a central cavity 133 provided in the first portion 111 of the main magnet system 115 and a central cavity 135 provided in the second portion 113 of the main magnet system 115. During operation the superconducting coils 121 of the main magnet system 115 are used to generate a magnetic field which has a vertically oriented main field portion 137 with a substantially constant magnetic field strength B₀ in a portion of the examination volume 109. The gradient coils of the gradient magnet system 127 are used to generate altering gradients of the main field portion 137 in accordance with the nuclear magnetic resonance method used.

Like the gradient magnet system 13 of the MRI system 1 shown in FIG. 1, the first portion 123 and the second portion 125 of the gradient magnet system 127 of the MRI system 101 are susceptible to mechanical vibrations which are caused, during operation, by alternating Lorentz forces exerted on the gradient coils of the gradient magnet system 127. The first portion 123 and the second portion 125 of the gradient magnet system 127 are mounted in the respective conical portions 131 of the central cavities 133, 135 by means of elastic suspension members, not shown in FIG. 2. As a result the high-frequency components of the vibrations of said first and second portions 123, 125 are considerably limited. However, particularly the low-frequency components of the vibrations of said first and second portions 123, 125 are not adequately limited by said elastic suspension members, and would lead to unacceptable distortions of the gradients of the main field portion 137 and to unacceptable distortions of the image generated by the MRI system 101 if no further measures were taken.

In order to limit the vibrations of the first portion 123 and the second portion 125 of the gradient magnet system 127, the MRI system 101 is provided with a damping member comprising a first conductive member 139 mounted to the first portion 123 of the gradient magnet system 127 and a second conductive member 141 mounted to the second portion 125 of the gradient magnet system 127. In the embodiment shown, the first conductive member 139 and the second conductive member 141 each comprise a substantially circular cylindrical plate 143 made of a material having a relatively high electrical conductivity, preferably a metal such as copper or aluminium. It is noted that the plates 143 are only partially shown in FIG. 2 for the sake of clarity, but that in reality the plates 143 constitute closed cylindrical bodies. The circular cylindrical plate 143 of the first conductive member 139 is concentrically arranged in a circular cylindrical portion 145 of the central cavity 133 provided in the first portion 111 of the main magnet system 115, while the circular cylindrical plate 143 of the second conductive member 141 is concentrically arranged in a circular cylindrical portion 145 of the central cavity 135 provided in the second portion 113 of the main magnet system 115, both circular cylindrical portions 145 being arranged remote from the examination volume 109. FIG. 2 also shows that the MRI system 101 is also provided with a number of electrically conductive plates 147, which are mounted to the housings 117 of the first and second portions 111, 113 of the main magnet system 115 in order to damp vibrations of the housings 117. Said plates 147 will not be further discussed here as their functions and effects are similar to the functions and effects of the plates 29, 35, 37 of the MRI system 1 as discussed before.

The portions of the magnetic field of the main magnet system 115 present in the cylindrical portions 145 of the central cavities 133, 135 have a sufficiently large magnetic field strength-to cause the conductive members 139, 141 to have an adequate damping effect. Since the cylindrical portions 145 of the central cavities 133, 135 are positioned remote from the examination volume 109, a sufficiently large distance is present between the conductive members 139, 141 and the main field portion 137 to prevent the eddy currents in the conductive members 139, 141 from causing unacceptable distortions of the main field portion 137 and of the image generated by the MRI system 101. Since in this manner each portion 123, 125 of the gradient magnet system 127 is individually mounted to a separate conductive member 139, 141, the vibrations of each portion 123, 125 of the gradient magnet system 127 are individually and thus effectively damped. As a result of the circular cylindrical shape of the conductive members 139, 141 the available volumes of the circular cylindrical portions 145 of the central cavities 133, 135 are optimally used for the accommodation of the conductive members 139, 141. The portions of the magnetic field of the main magnet system 115 in the central cavities 133, 135 are oriented in the vertical direction, i.e. substantially parallel to the central axes of the central cavities 133, 135 and substantially parallel to the surfaces of the circular cylindrical plates 143. This orientation of the magnetic field relative to the plates 143 provides an optimum damping effect of the conductive members 139, 141.

It is noted that instead of the circular cylindrical plates 143 other kinds of conductive members can be used instead of the conductive members 139, 141 such as, for example, a number of parallel flat plates which are oriented in the vertical direction in the circular cylindrical portions 145 of the central cavities 133, 135. Another example of an alternative conductive member 149, which can be used in the MRI system 101 instead of the conductive members 139, 141, is schematically shown in FIG. 3. In FIG. 3 a part of the first portion 123 of the gradient magnet system 127 is shown. The alternative conductive member 149 comprises a carrier 150 which is made from an electrically non-conductive material, in particular a rigid synthetic material. The conductive member 149 further comprises a closed conductive metal winding 151, in this embodiment made from a copper wire, which is rigidly mounted to the carrier 150. The winding 151 has winding portions 153, 155, 157, 159 which extend substantially parallel to the central axis of the central cavity 133, i.e. substantially parallel to the magnetic field in the central cavity, so that these winding portions 153, 155, 157, 159 provide an optimum damping effect of the conductive member 149. In the embodiment shown in FIG. 3 the winding 151 has a first relatively short loop 161 at a side facing the examination volume 109 and a second relatively long loop 163 at a side remote from the examination volume 109, said first and second loops 161, 163 being mutually connected by crossing winding portions 165, 167. As a result of this configuration of the winding 151, the influence of the eddy currents in the winding 151 on the main field portion 137 is further reduced.

From the foregoing description of the embodiments it will be clear that the invention broadly covers the use of an eddy-current based damping member in an MRI system to damp the vibrations of a part of the MRI system and the magnetic field generating portions of the main magnet system relative to each other. Accordingly, the damping member can be used to damp the vibrations which said part has relative to the magnetic field, but can also be used to damp the vibrations which the magnetic field generating portions of the main magnet system have relative to a part of the MRI system which is hardly susceptible to vibrations. The damping member may be mounted to any part of the MRI system which is susceptible to vibrations relative to the magnetic field, provided that the conductive member of the damping member is arranged in a secondary portion of the magnetic field having a magnetic field strength which differs by more than 25% from the magnetic field strength of the main field portion. Thus, the damping member may, for example, also be mounted to frame parts or to other housing parts or system enclosing parts of the MRI system susceptible to vibrations relative to the magnetic field. In the MRI system 1, for example, an additional damping member may be mounted to the gradient magnet system 13 to damp the vibrations of the gradient magnet system 13. In order to prevent unacceptable distortions of the main field portion 17 by the eddy currents in such an additional damping member, the conductive member of said additional damping member may, for example, be arranged outside the examination volume 11 and be connected to the gradient magnet system 13 by additional rigid mounting members. In the case of a relatively long cylindrical examination volume 11, the damping members may possibly be mounted near the annular end walls of the cylindrical housing of the gradient magnet system 13. From the foregoing description of the embodiments it will also be clear that the invention is not limited to the specific embodiments of the damping members and conductive members shown in the Figures.

1. A magnetic resonance imaging (mri) system comprising an examination volume, a main magnet system for generating a magnetic field having a main field portion with a substantially constant magnetic field strength in the examination volume, a gradient magnet system for generating gradients of the main field portion, and a damping member which is mounted to a part of the mri system susceptible to vibrations relative to the magnetic field during operation, said damping member comprising an electrically conductive member which is present in the magnetic field and in which eddy currents are generated as a result of said vibrations, wherein the conductive member is arranged in a secondary portion of the magnetic field at a distance from the main field portion, the secondary portion having a magnetic field strength which differs by more than 25% from the magnetic field strength of the main field portion:

2. An MRI system as claimed in claim 1, wherein the magnetic field strength of the secondary portion differs by more than 50% from the magnetic field strength of the main field portion.

3. An MRI system as claimed in claim 1, wherein the conductive member is arranged in a stray field portion of the magnetic field.

4. An MRI system as claimed in claim 1, wherein the conductive member is mounted to the gradient magnet system.

5. An MRI system as claimed in claim 4, wherein the main magnet system comprises a first substantially rotationally symmetrical portion and a second substantially rotationally symmetrical portion at a distance from the first portion, wherein the examination volume is present between the first and the second portion, and wherein the gradient magnet system comprises a first and a second portion arranged, respectively, in a central cavity of the first portion of the main magnet system and in a central cavity of the second portion of the main magnet system, a first and a second conductive member being mounted, respectively, to the first portion of the gradient magnet system and to the second portion of the gradient magnet system and being arranged, respectively, in a portion of the central cavity of the first portion of the main magnet system remote from the examination volume and in a portion of the central cavity of the second portion of the main magnet system remote from the examination volume.

6. An MRI system as claimed in claim 5, wherein the first and the second conductive member each comprise a substantially circular cylindrical metal plate which is concentrically arranged relative to, respectively, the first portion of the main magnet system and the second portion of the main magnet system.

7. An MRI system as claimed in claim 5, wherein the first and the second conductive member each comprise a closed conductive metal winding having winding portions extending substantially parallel to a central axis of, respectively, the first portion of the main magnet system and the second portion of the main magnet system.

8. An MRI system as claimed in claim 1, wherein the conductive member is mounted to a housing of the main magnet system.

9. An MRI system as claimed in claim 8, wherein the main magnet system and the gradient magnet system are substantially circular cylindrical, wherein the gradient magnet system surrounds the examination volume and the main magnet system surrounds the gradient magnet system, the conductive member being mounted to an annular end wall of the housing of the main magnet system.

10. An MRI system as claimed in claim 8, wherein the main magnet system and the gradient magnet system are substantially circular cylindrical, wherein the gradient magnet system surrounds the examination volume and the main magnet system surrounds the gradient magnet system, the conductive member being mounted to a portion of a cylindrical outer wall of the housing of the main magnet system adjacent to an annular end wall of said housing.

11. An MRI system as claimed in claim 8, wherein the conductive member is mounted to a support member which supports the housing of the main magnet system.

12. An MRI system is claimed in claim 8, wherein conductive member comprises a substantially flat metal plate.
